(19) United States
(12) Patent Application Publication
(10) Pub. No.: US 2013/0022037 A1
(43) Pub. Date: Jan. 24, 2013

(54) METHOD, TERMINAL DEVICE, AND SYSTEM FOR ESTABLISHING A COMMUNICATION BETWEEN A FIRST PARTY AND A SECOND PARTY

(71) Applicant: Walter Keller, Ratingen (DE)

(72) Inventor: Walter Keller, Ratingen (DE)

(73) Assignee: Deutsche Telekom AG, Bonn (DE)

(21) Appl. No.: 13/515,038

(22) PCT Filed: Dec. 7, 2010
(86) PCT No.: PCT/EP2010/007427

§ 371 Date: Sep. 21, 2012

Related U.S. Application Data
(60) Provisional application No. 61/285,012, filed on Dec. 9, 2009.

(30) Foreign Application Priority Data
Dec. 9, 2009 (EP) 09015267.9

(51) Int. Cl. H04L 12/66

(52) U.S. Cl. 370/352

(57) ABSTRACT

A method for establishing a communication between a first party and a second party includes: receiving, by the second party, a communication request (CR) and identification information of the first party from the first party using a first signalization standard and using public identification information of the second party; and establishing direct communication between the first and the second party using a second signalization standard and using the identification information of the first party. The first signalization standard corresponds to a Public Switched Telephone Network (PSTN) or Public Land Mobile Network (PLMN) service or to Internet Protocol. The second signalization standard corresponds to Internet Protocol.

### CROSS-REFERENCE TO RELATED APPLICATIONS

This patent application is a national stage entry under 35 U.S.C. §371 of International Application No. PCT/EP2010/007427, filed Dec. 7, 2010, and claims priority to European Patent Application No. EP 09015267.9, filed Dec. 9, 2009, and U.S. Provisional Patent Application No. 61/285,012, filed Dec. 9, 2009. The International Application was published in English on Jun. 16, 2011, as WO 2011/069639 A1.

### FIELD

The present invention relates to a method, a terminal device, a system, a program and a computer program product for establishing a communication between a first party and a second party.

### BACKGROUND

The establishment of communication in public or private networks using the Internet Protocol (hereinafter also referred to by the term “IP”) is usually done by way of a client-server method. Thereby, a server device can be reached by a multitude of clients in the network. The server device usually has a static (and probably publicly known) IP-address which is either known to the client or can be requested by the client by way of a DNS-server (Domain Name System). The DNS-server includes or is assigned to a database including names, IP-addresses and/or alias names of the server devices connected to it. The client devices normally do not have static IP-addresses (at least normally according to the IPv4-version of the Internet Protocol).

In order to establish a direct communication between two client devices, different methods are presently known. One example of such communications are the so-called peer-to-peer connections (also called P2P-communication). Such a system requires the presence of a so-called overlay-network providing the functions of lookup and search for the connected client devices. By using the lookup function, peers are able to identify the (other) peer devices that are responsible for a specific object identification (also called object-ID). In such a case, the responsibility for a specific object is related to at least one of the peers. Such overlay-networks are also called structured overlays. By using the search function, peers are able to search the network for objects that are fulfilling specific criteria. In such a case, the responsibility for a specific object is not related to specific peer. Such overlay-networks are also called non-structured overlays. Examples of such peer to peer networks include the Gnutella-network or the JXTA network. The known peer to peer networks require that a specific client is only reachable in case this specific client is connected, i.e. the (dynamic) IP-address is known to a server device.

Another example of a direct communication between two client devices is Voice-over-IP (VOIP) telephony. Such systems include so-called VOIP-Gateways that provide a connection between the telephone network and the IP-network. In order to use VOIP-telephony, so-called SIP-protocols (Session Initiation Protocol) are used. The calling client device registers at a server device that is aware about the currently reachable client devices. Such a system is e.g. the Skype system.

A method for establishing a communication between an initiating first device and a target client device without the use of a central server device that knows the target client device or without the use of a dynDNS service is not known so far.

### SUMMARY

In an embodiment the present invention provides a method for establishing a communication between a first party and a second party. The method includes: receiving, by the second party, a communication request (CR) and identification information of the first party from the first party using a first signalization standard and using public identification information of the second party; and establishing direct communication between the first and the second party using a second signalization standard and using the identification information of the first party. The first signalization standard corresponds to a Public Switched Telephone Network (PSTN) or Public Land Mobile Network (PLMN) service or to Internet Protocol. The second signalization standard corresponds to Internet Protocol.

### BRIEF DESCRIPTION OF THE DRAWINGS

FIG. 1 shows schematically a plurality of terminal devices and network instances.

FIG. 2 shows schematically the communication between the first and second party in a method according to an embodiment of the present invention.

FIGS. 3 and 4 show schematically two alternative embodiments of a method according to the present invention.

### DETAILED DESCRIPTION

Embodiments of the present invention provide a method, a terminal device, a system, a program and a computer program product for establishing and realizing a communication between a first party and a second party in a communication network. Such a communication should avoid at least partly the above mentioned drawbacks of the prior art. It is therefore proposed to use an IP-communication between at least a first party and a second party (optionally of course also more than two parties) without the need of a central server device providing a database function for dynamic IP-addresses. A communication is any communication contact between the first party and the second party using any communication channel. A communication is, e.g., an incoming telephone call, an incoming video call, an incoming SMS, an incoming MMS, an incoming email, an incoming IM (instant message) or an incoming OSN (open social network) message.

In an embodiment, a method is provided for establishing a communication between a first party and a second party, the communication establishment including at least a first step and a second step, wherein the first step includes the transmission by the first party of a communication request to the second party using a first signalization standard and using a publicly known first identification information of the second party, wherein the first step further includes the transmission by the first party of a second identification information of the first party, and wherein the second step includes the communication establishment using the second identification information by the second party using a second signalization standard.

In a further embodiment, a method is provided for establishing a communication between a first party and a second party, the communication establishment including at least a first step and a second step, wherein the first step includes the transmission by the first party of a communication request to the second party using a first signalization standard and using a publicly known first identification information of the second party, wherein the first step further includes the transmission by the first party of a second identification information of the first party, and wherein the second step includes the communication establishment using a second signalization standard and using the second identification information, wherein the communication between the first party and the second party is established directly between the first party and the second party, and wherein the first signalization standard corresponds to a Public Switched Telephone Network (PSTN) or Public Land Mobile Network (PLMN) service or to the Internet Protocol and wherein the second signalization standard corresponds to the Internet Protocol.

In an embodiment, it is advantageously possible that the first party sends a communication request to the second party via a first signalization standard, i.e., using a communication network and a respective signalization method. The exchange of content information or data is conducted via a second signalization standard or communication standard. The communication request uses a known or static address of the second party which is hereinafter also called the first identification information. This first identification information identifies the second party. In an embodiment, the first signalization or communication standard (by way of which the communication request (CR) is transmitted to the second party) includes, e.g., an E-mail communication or an SMS (Short Message Service)-communication or an ISDN (Integrated Services Digital Network) signalization or an UDS-datagram or a URL (Uniform Resource Locator) communication or a communication via an IP (Internet Protocol) network according to IPv6 using a public IPv6-address. In an embodiment, the communication standard used for transmitting the communication request is only used for signalization purposes and not for the communication itself, i.e., not for the transport of content information such as a telephone conversation or data file or a video stream. In an embodiment, the communication request is transmitted using a wire-bound technology and/or a wireless technology.

The communication between the first party and the second party is established directly between the first party and the second party. This means that between the first party and the second party, there are no other specific network elements—except, of course, network elements that serve to establish the communication link such as switching elements or other network elements that are not specific to the communication link to be established—that specifically provide for the establishment of this communication link between the first and the second party.

In an embodiment, a second identification information of the first party is transmitted to the second party by way of the communication request. The second identification information preferably includes the dynamic IP-address or the static IP-address of the first party. The second identification information preferably also includes an identifier regarding the first party such as the name of the first party, the telephone number of the first party, the e-mail address of the first party. Using the identifier of the first party, the second party is able to recognize the first party at least such that it is possible for the second party to decide whether the communication request of the first party should be answered or allowed or not.

In an embodiment, the second identification information may include a lifetime information. Such a lifetime information relating to the second identification information indicates an absolute point in time or indicates a time interval after the transmission of the communication request and is provided such that after the specified absolute point in time or after the specified time interval has elapsed the second identification information is no longer valid, i.e., the second party cannot (reliably) use the second identification information within the second step according to the inventive method.

In an embodiment, after the second party has received the second identification information, the communication between the first and the second party can be established in a second step of the inventive method using the second identification information. For example, the second party can establish the communication with the first party.

In an embodiment, the method includes a third step, wherein the third step includes the transmission by the second party of a third identification information to the first party, wherein the third identification information is different from the first identification information, wherein the third step is performed after the first step and prior to or during the second step, wherein it is preferred that the first identification information is a public identification information of the second party and that the third identification information is a private or a non-permanent identification information of the second party.

It is thereby advantageously possible that the first party does not need to know the third identification information as this information is transmitted to the first party only in case that the second party wants this third identification information to be transmitted to the first party. For example, the third identification information can be a dynamic IP-address or an alias-name about which the first party is informed only by way of the third step of the inventive method.

In an embodiment, the first signalization standard corresponds to a payable service and the second signalization standard corresponds to the Internet Protocol, wherein preferably the second identification information includes an IP-address or relates to an IP-address or includes an URL (Uniform Resource Locator), and wherein preferably the first identification information includes a telephone number of a PSTN (Public Switched Telephone Network) or a PLMN (Public Land Mobile Network).

In an embodiment, it is advantageously possible that the first party sends the communication request to the second party via a communication network or according to a signalization standard corresponding to a payable service using a static or known address of the second party and that the exchange of content information or data can be conducted via a second signalization or communication standard corresponding especially to the Internet Protocol (IP-protocol). The first communication standard is, e.g., a communication standard being payable such as a PSTN or PLMN telephone call, and that the second communication standard is a communication standard which can be used for free, e.g. as the IP-protocol. In such an example, the second identification information includes, e.g., the IP-address of the first party such that the second party can—after the reception of the communication request—establish the communication using the IP-protocol and the IP-address of the first party. Preferably, the second party also transmits (in the third step) the IP-address of the second party to the first party such that a bidirectional communication is possible, e.g. for the transmission of data, voice and/or image content.

In a further embodiment, the first signalization standard corresponds to the Internet Protocol and the second signalization standard corresponds to the Internet Protocol. Thereby, it is advantageously possible to use the IP-protocol for both signalization and communication.

In a further embodiment, the method includes a fourth step, wherein the fourth step includes the second party checking the validity of the communication request of the first party, the fourth step being performed after the first step and prior to the third step, wherein the fourth step preferably includes displaying of the second identification information of the first party (especially the identifier part of the second identification information) on a display device assigned to the second party, wherein preferably the fourth step furthermore includes the second party manually or automatically validating the communication request of the first party. Thereby, it is advantageously possible that the communication is established only in those cases where the second party agrees on such a communication, e.g. the second party only establishes the communication (second step) in case that the identifier (e.g. the IP-address) transmitted by way of the second identification information is validated, e.g., that the first party can be recognized.

In an embodiment, a terminal device is provided for realizing a communication between a first party and the terminal device, wherein the terminal device includes a reception unit for receiving a communication request using a first signalization standard and using a publicly known first identification information of the terminal device, wherein the reception unit of the terminal device is provided for receiving a second identification information of the first party, and wherein the terminal device includes transmission unit for communication establishment using the second identification information and using a second signalization standard.

It is advantageously possible that the first party sends a communication request to the terminal device (i.e. the second party) via the first signalization standard and that the exchange of content information or data is conducted via the second signalization standard or communication standard. The communication request uses a known or static address of the terminal device which is hereinafter also called the first identification information.

In a further embodiment, the terminal device is configured to transmit a third identification information to the first party, wherein the third identification information is different from the first identification information, wherein it is preferred that the first identification information is a public identification information of the second party and that the third identification information is a private or a non-permanent identification information of the second party.

It is thereby advantageously possible that the first party does not need to know the third identification information as this information is transmitted to the first party only in case that the terminal device (or the second party) wants this third identification information to be transmitted to the first party. For example, the third identification information can be a dynamic IP-address or an alias-name about which the first party is informed only by way of the third step of the inventive method.

In an embodiment, the first signalization standard corresponds to a payable service and that the second signalization standard corresponds to the Internet Protocol, wherein preferably the second identification information includes an IP-address or relates to an IP-address or includes an URL (Uniform Resource Locator), and wherein preferably the first identification information includes a telephone number of a PSTN (Public Switched Telephone Network) or a PLMN (Public Land Mobile Network).

In an embodiment, it is advantageously possible that the first party sends the communication request to the terminal device via a communication network or according to a signalization standard corresponding to a payable service using a static or known address of the terminal device and that the exchange of content information or data can be conducted via a second signalization or communication standard corresponding especially to the Internet Protocol (IP-protocol).

In a further embodiment, the terminal device includes a unit for checking the validity of the communication request of the first party, the terminal device preferably including a display for displaying the second identification information of the first party.

In an embodiment, a system is provided for realizing a communication between a first party and a second party, wherein the first party includes a transmission unit for transmitting a communication request to the second party using a first signalization standard and using a publicly known first identification information of the second party, wherein the second party includes a reception unit for receiving the communication request, wherein the reception unit of the second party is provided for receiving a second identification information of the first party, and wherein the second party includes a transmission unit for communication establishment using the second identification information and using a second signalization standard.

In an embodiment, a program is provided including a computer readable program code for realizing a communication between a first party and a second party, wherein the first party includes a transmission unit for transmitting a communication request to the second party using a first signalization standard and using a publicly known first identification information of the second party, wherein the second party includes a reception unit for receiving the communication request, wherein the reception unit of the second party is provided for receiving a second identification information of the first party, and wherein the second party includes a transmission unit for communication establishment using the second identification information and using a second signalization standard.

In an embodiment, a computer program product is provided including a computer readable program code for realizing a communication between a first party and a second party, wherein the first party includes a transmission unit for transmitting a communication request to the second party using a first signalization standard and using a publicly known first identification information of the second party, wherein the second party includes a reception unit for receiving the communication request, wherein the reception unit of the second party is provided for receiving a second identification information of the first party, and wherein the second party includes a transmission unit for communication establishment using the second identification information and using a second signalization standard.

Embodiments of the present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described of illustrated herein.

Any person skilled in the art will understand that other modifications or varieties of the invention are possible without departing from the broader spirit of the invention. Such modifications are therefore to be considered as falling within the spirit and the scope of the invention and hence forming part of the invention as herein described or exemplified. Accordingly the exemplary description is to be regarded in an illustrative sense rather than in a restrictive sense.

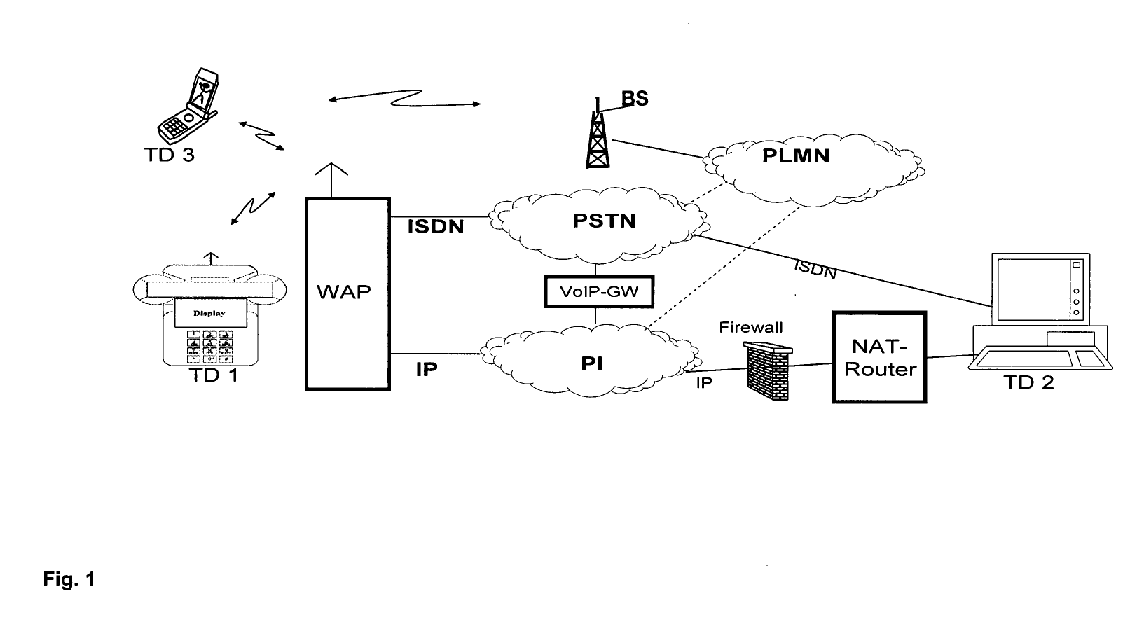

FIG. 1 shows schematically a first terminal device TD1, a second terminal device TD2 and a third terminal device TD3. For example, the first terminal device TD1 is shown as a wireless telephone device, the second terminal device TD2 is represented as a personal computer device having communications capabilities, and the third terminal device TD3 is represented as a mobile devices such as a mobile telephone, a personal digital assistant (PDA), a smart phone device or another handheld and mobile device. FIG. 1 furthermore exemplarily shows networks, network instances or network entities such as a NAT-Router, a base station (BS), a PLMN (Public Land Mobile Network) for mobile communications, a PSTN (Public Switched Telephone Network) for fixed line communications, a public IP-network (PI), Internet Protocol connections (IP), a Voice Over IP Gateway (VOIP-GW), a Wireless Access Point (WAP), connection over an Integrated Services Digital Network (ISDN). The PLMN can, e.g., be provided as a second generation network (2G network) and/or as a third generation network (3G network) and/or as an UMTS network (Universal Mobile Telecommunications System) and/or as an IP-network and/or as an All-IP-network. The PSTN can, e.g., also be provided as an IP-network and/or as an All-IP-network.

Exemplarily, the first and third terminal device TD1, TD3 are connected wirelessly (e.g. according to the IEEE 802.11n standard) to a Wireless Access Point (WAP, e.g. a DSL-WLAN Router (Digital Subscriber Line Wireless Local Area Network Router) or an a DSL-WLAN Router (asymmetrical Digital Subscriber Line Wireless Local Area Network Router)) which is connected via an ISDN connection to the PSTN and via an IP connection to the PI. The first terminal device TD1 may also be connected to the WAP by way of DECT connectivity (Digital Enhanced Cordless Telephone). The third terminal device TD3 is also represented as being connected to a base station (BS) (or NodeB, eNodeB) of the PLMN, the PLMN being connected to the PSTN and the PI. The PSTN is connected via an ISDN connection to the second terminal device TD2. The PI is connected via an IP connection (and a Firewall device and an NAT Router) to the second terminal device TD2. A VOIP-gateway is provided connected both to the PSTN and to the PI network. All the terminal devices TD1, TD2, TD3 shown in FIG. 1 can preferably be used both as the terminal device of the first party according to the inventive method of the present invention and as the terminal device of the second party according to the inventive method of the present invention. In a further embodiment, it is furthermore possible that additional parties are involved in the communication process. The further terminal devices can be connected to the networks or network entities shown in FIG. 1.

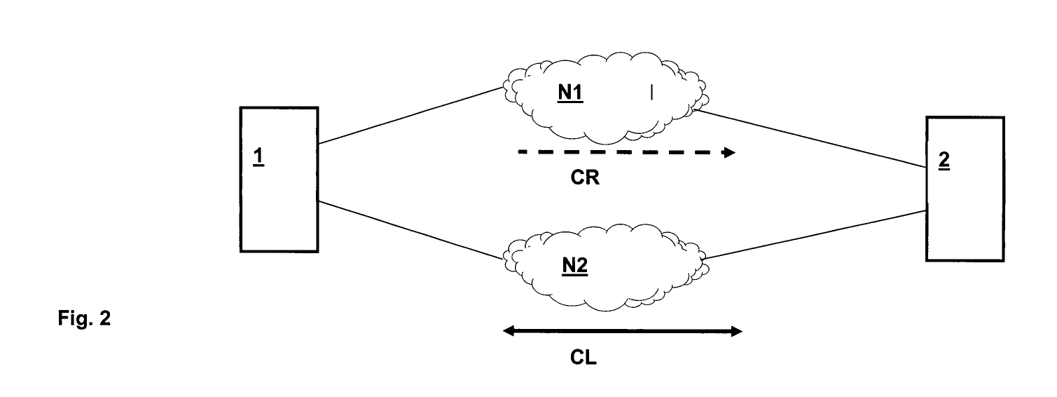

FIG. 2 shows schematically the communication between a first party 1 and a second party 2 according to a method in an embodiment of the present invention. In a first step of the inventive method, the first party 1 sends or transmits a communication request CR to the second party 2. This is done using a first signalization standard and using a first communication network N1. In a second step, the communication between the first party 1 and the second party 2 is established using a communication link CL according to a second signalization standard and a second communication network N2. Preferably, the communication request CR is checked by the second party 2 prior to establishing the communication link CL, i.e. by way of the second identification information, especially the identifier of the first party 1, the first party 1 can be recognized by the second party 2 such that a decision is possible whether the communication request CR should be answered or not. One possible application of the present invention relates to the field of voice communication between the first party 1 and the second party 2, but this is only an example used primarily for the sake of illustration only. Embodiments of the present invention are not restricted to voice communication but can be applied to any kind of voice, data, image, video or other communication between two or more terminal devices such as personal computers, automated communication machines, handheld devices, personal digital assistants (PDA), mobile phones, notebook devices, game consoles and/or telephones of any kind

The choice of the first communication network N1 and the second communication network N2 can be done for a multitude of reasons like, e.g., transmission costs, transmission bandwidth, quality of service, demand in energy (especially regarding mobile devices having only a limited power budget), arbitrary choice of the party bearing the communication costs (e.g. the first party could initiate the communication but the second party could bear all or at least mainly the costs).

The first party 1 can, for example, be a mobile handset connected simultaneously to a plurality of networks, e.g. a GSM network (relatively slow but widely used, cheap, supported with good indoor-coverage as well as low power requirements for radio transmission), an LTE Long Term Evolution IP network (high speed but only hotspot coverage, expensive and especially high power consumption for radio transmission) (as examples of PLMN networks) as well as fixed network via WLAN router and DSL modem (high speed access, cheap but only accessible close to the router).

The choice of the communication link CL depends, e.g., on the mobility behavior of the first party 1, the needed transmission bandwidth, the power consumption (battery load) and the transmission cost, whereas the preference can be predefined and stored by the user or (e.g. automatically) optimized by the device.

The communication between the first party 1 and the second party 2 is established directly between the first party 1 and the second party 2. This means that between the first party 1 and the second party 2, there are no other specific network elements—except, of course, network elements that serve to establish the communication link such as switching elements or other network elements that are not specific to the communication link to be established—that specifically provide for the establishment of this communication link between the first and the second party 1, 2. This is represented in FIGS. 1 and 2.

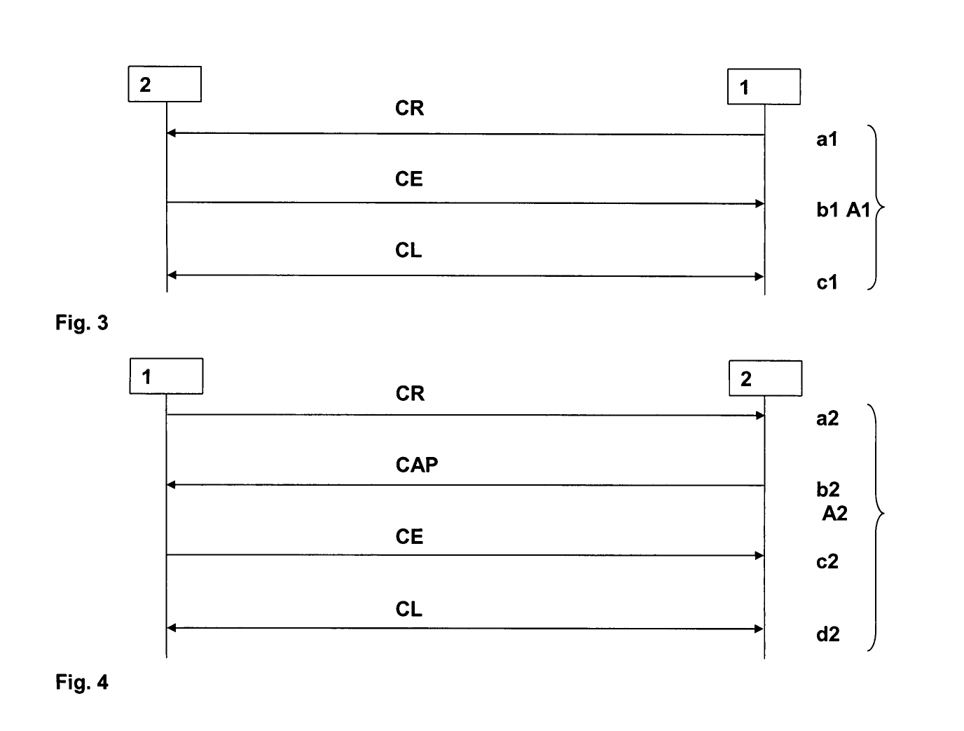

FIGS. 3 and 4 schematically show two alternative embodiments of the method according to the present invention.

According to the first alternative embodiment (A1) shown in FIG. 3, the communication link CL is established (c1) by the following steps:

the first step a1, corresponding to the communication request CR, and

the second step b1, corresponding to the communication establishment CE.

For example, the first party 1 (e.g. the second terminal device TD2) wants to establish a voice communication with the second party 2 (e.g. the third terminal device TD3). For example, the first party 1 is located abroad such that a classic voice communication would, especially by using a PLMN in one or both countries, involve considerable (roaming) costs or the like. In this example, the first party 1 uses a known and static first identification information in order to contact the second party 2. The first identification information of the second party 2 might be a telephone number (fixed line or mobile) and/or an SMS-Number, and/or a Fax-Number, and/or an e-mail-address, and/or an UDS-datagram, and/or a static IP-address (e.g. from the IPv6 part of public IP-addresses). For example, the first party 1 uses the telephone number of the second party 2 for the first step, namely the communication request CR. The first party 1 either manually or automatically dials the telephone number of the second party 2.

By way of the transmission by the first party 1 of further information, it is possible that a second identification information can be made known to the second party 2. This is possible with any way of providing the possibility of additionally transmitting the second identification information besides the telephone number of the first party. The second identification information can, e.g., be transmitted by using the ISDN characteristics CLIP (Calling Line Identification Presentation) with the addition SUB (subaddressing). Alternatively, the second identification information can be transmitted by using the ISDN characteristics “CLIP (Calling Line Identification Presentation)—no screening”. Furthermore alternatively, the second identification information can be transmitted by using the signalization method according to U.S. Pat. No. 6,963,638 B1 which is incorporated herein by reference in its entirety. According to these possibilities, it is possible that additional information from the first party to the second party is transmitted during the call signalization, in the present case the transmission of the second identification information in addition to the telephone number of the first party.

For example, the second identification information is the public IP-address, preferably together with a name of the first party, an alias name of the first party, a Uniform Resource Locator of the first party or of another target device, an e-mail-address of the first party (also called identifier of the first party) or another suitable address. Further preferably, the second identification information includes information regarding the communication service requested by the first party, e.g. voice communication by way of the VOIP protocol.

For example, the ISDN characteristics “CLIP—no screening” only allows for the transmission of a specified call back number to be used by the called party. The IP-address of the first party is transmitted as the call back number by the first party. For example, the usual IPv4 IP-address including four numbers from 0 to 255 separated by dots could be transformed or transcribed into a usual ISDN number by way of omitting the dots and replacing leading zeros. Alternatively, a leading zero is added to the number obtained.

Still for the case of a voice communication to be established between the first and second party, the second identification information is transmitted to the second party during the call signalization. In an embodiment, the second identification information is displayed by a display. The terminal device of the second party 2 is preferably provided such that IPv4 IP-address is displayed in the normal manner, i.e. without the leading zeros, or such that the second identification information are displayed in a different representation. Furthermore, it is possible that the terminal device of the second party 2 is provided such that, e.g. by way of a microcontroller, the terminal device is able to additionally display the caller name assigned to the number of the calling party in a local or remote database. In an embodiment, at least the calling number, the requested communication service and the IP-address of the caller are displayed. In a further embodiment, based on the second identification information, the validity of the communication request (CR) of the first party 1 is checked.

The second party 2 is then able to decide whether the communication request should be answered and the communication established. Until the described situation during the signalization prior to an established voice communication, the communication is free of charge in most of the PLMN networks and PSTN networks. The second party is then able to initiate the communication by way of the second identification information received by the first party 1. Alternatively to the described transmission of the second identification information by way of a signalization communication prior to a normal voice communication, the second identification information can also be transmitted from the first party 1 to the second party 2 by way of other communication channels, e.g. by e-mail and/or by SMS and/or by facsimile or the like.

If the second party 2 decides to establish the communication with the first party 1, the communication request CR is acknowledged by way of an IP-connection established to the IP-address transmitted by the first party 1. The establishment of the IP-connection is preferably realized automatically by the second party 2 using a communication unit, wherein the communication unit is preferably controlled by a microcontroller. The described example of the establishment of a voice communication between the first party 1 and the second party 2 shows that a voice communication, especially an international call, can easily be established via an IP-network by using the signalization communication in a PLMN network and/or a PSTN network but without transmitting content information via these networks.

Alternatively to the example described above, at least one of the communication parties 1, 2 does not transmit an IP-address but an indirect reference, e.g. a Uniform Resource Locator, a DynDNS-alias, an e-mail or a FQDN (Fully Qualified Domain Name).

According to a second alternative embodiment (A2) shown in FIG. 4, the communication link CL is established (d2) by the following steps:

a first step a2, corresponding to the communication request CR,

a third step b2, corresponding to the transmission of the third identification information from the second party 2 to the first party 1 (also called CAP, Communication Address Provision) such that the first party 1 is able to use the third identification information for the establishment of the communication in the second step c2,

a second step c2, corresponding to the communication establishment CE.

For example, the first party 1 (e.g. the third terminal device TD3) wants to establish a voice communication with the second party 2 (e.g. the second terminal device TD2). It is particularly useful to use an all-IP-network. In an all-IP-network, each party can use at least one static IP-address (i.e. from the public part of IPv6). For safety reasons, it might be advantageous not to use the public (static) IP-addresses. In the example given with regard to the second embodiment of the present invention, the static IP-address is only used for signalization purposes during the communication request whereas for the transmission of the content, an IP-address different from the public IP-address is used, e.g. a further public IP-address to be used by a limited number of persons (e.g. friends) or a dynamic IP-address, preferably a dynamic IP-address to be used only once.

In this example, the first party 1 uses a public IPv6-address of the second party 2 as a known and static first identification information in order to contact the second party 2 for signalization purposes. Optionally, the first party 1 can use the DNS-method and/or the Uniform Resource Locator and/or the telephone number and/or the e-mail-address of the second party 2, e.g. using the PLMN network and the PI network (alternatively using the WAP and/or PSTN network). The first identification information of the second party 2 might be a telephone number (fixed line or mobile) and/or an SMS-Number, and/or a Fax-Number, and/or an e-mail-address, and/or an UDS-datagram, and/or a static IP-address (e.g. from the IPv6 part of public IP-addresses). For example, the first party 1 uses the telephone number of the second party 2 for the first step, namely the communication request CR.

By way of the transmission by the first party 1 of further information, it is possible that the second identification information can be made known to the second party 2. In contrast to the first alternative embodiment Al depicted in FIG. 3, no ISDN characteristics is used to transmit the second identification information but an IP-datagram for call signalization purposes. A microcontroller unit of the terminal device of the second party 2 analyzes the incoming message and provides for the conversion, and preferably the display of relevant information as well as a database request. As an example, the case of an e-mail transmission request is described where the first party 1 requests the transmission of an e-mail to the second party 2. The second party 2 transmits the third identification information to the first party 1, e.g. in the form of an e-mail-address that can only be used once. Then, the first party 1 transmits the e-mail using the received e-mail-address.

In an embodiment, a specific public IP-address (possibly together with a Universal Resource Locator (URL)) is assigned to the second party 2 such that this public IP-address (and alternatively or cumulatively this URL) is usable for signalization purposes for all kinds of communication requests in an all-IP-network as a universal IP-address (for the second party 2). By way of using a different IP-address (e.g. non-publicly known or dynamic or non-persistent IP-address), i.e. the address information included by the third identification information, for transmitting the content data of the requested communication, it is possible that such a communication can be realized in a very safe and secure manner. As mentioned before, the communication is requested by the first party 1 and verified or validated by the second party 2. Only after this validation step (and the transmission of the third identification information) the communication is possible according to the second alternative embodiment A2 shown in FIG. 4.

In case of several possible communication channels or communication networks or communication modes (e.g. regarding quality parameters (quality of service), payment method, cost-bearer) available (to the second party 2) for realizing a specific communication requested (by the first party 1), the second party 2 is able to chose the communication channel or communication network or communication modes to use by transmitting a different third identification information (e.g. by transmitting an IP-address and/or an URL, and/or an e-mail-address and/or an FQDN indicating where the IP-address can be found) such that the third identification information is specific to the chosen communication channel or communication network or communication mode. This can, e.g., be performed by way of the second party transmitting its IP-address or other signalization messages or signalization information concerning or specifying the choice of the communication channel or communication network or communication mode to be used for the communication. The choice of the communication channel or communication network or communication mode can be based on, e.g., the available communication bandwidth, the communication quality (quality of service), the electrical power requirements for performing the communication, the communication costs, and/or the question whether the first party or the second party (or potentially a third party) is bearing the communication costs.

1-15. (canceled)

16. A method for establishing a communication between a first party and a second party, the method comprising:
receiving, by the second party, a communication request (CR) and identification information of the first party from the first party using a first signalization standard and using public identification information of the second party; and
establishing direct communication between the first and the second party using a second signalization standard and using the identification information of the first party;
wherein the first signalization standard corresponds to a Public Switched Telephone Network (PSTN) or Public Land Mobile Network (PLMN) service or to Internet Protocol; and
wherein the second signalization standard corresponds to Internet Protocol.

17. The method according to claim 16, comprising:
after receiving the communication request, transmitting, by the second party, private or non-permanent identification information of the second party to the first party.

18. The method according to claim 16, wherein the identification information of the first party comprises an IP-address, relates to an IP-address, or comprises a URL (Uniform Resource Locator), and wherein the public identification information of the second party comprises a telephone number of a PSTN or a PLMN.

19. The method according to claim 17, comprising:
checking, by the second party, the validity of the CR before transmitting the private or non-permanent identification information of the second party to the first party.

20. The method according to claim 19, wherein checking the validity of the CR comprises:
displaying the identification information on a display corresponding to the second party.

21. The method according to claim 19, wherein checking the validity of the CR comprises:
manually or automatically validating, by the second party, the CR.

22. The method according to claim 16, wherein the identification information of the first party is transmitted to the second party using the ISDN characteristics CLIP (Calling Line Identification Presentation) with the addition SUB (subaddressing).

23. The method according to claim 16, wherein the identification information of the first party comprises a lifetime information.

24. A terminal device corresponding to a second party for realizing a communication between a first party and the second device, the terminal device comprising:
a reception unit configured to receive a communication request (CR) and identification information of the first party from the first party using a first signalization standard and using public identification information of the second party; and
a transmission unit configured to establish direct communication between the first and the second party using a second signalization standard and using the identification information of the first party;
wherein the first signalization standard corresponds to a Public Switched Telephone Network (PSTN) or Public Land Mobile Network (PLMN) service or to Internet Protocol; and
wherein the second signalization standard corresponds to Internet Protocol.

25. The terminal device according to claim 24, wherein the transmission unit is further configured to transmit private or non-permanent identification information of the second party to the first party.

26. The terminal device according to claim 24, wherein the identification information of the first party comprises an IP-address, relates to an IP-address, or comprises an URL (Uniform Resource Locator), and wherein the public identification information of the second party comprises a telephone number of a PSTN or a PLMN.

27. The terminal device according to claim 24, further comprising:
a unit for checking the validity of the CR; and
a display for displaying the identification information of the first party.

28. A system for realizing a communication between a first party and a second party, the system comprising:
a first terminal device corresponding to the first party, the first terminal device comprising:
a transmission unit configured to transmit a communication request (CR) to the second party using a first signalization standard and using public identification information of the second party; and
a second terminal device corresponding to the second party, the second terminal device comprising:
a reception unit configured to receive the CR and identification information of the first party; and
a transmission unit configured to establish direct communication between the first party and the second party using the identification information of the first party and using a second signalization standard;
wherein the first signalization standard corresponds to a Public Switched Telephone Network (PSTN) or Public Land Mobile Network (PLMN) service or to Internet Protocol; and
wherein the second signalization standard corresponds to Internet Protocol.

29. A non-transitory computer-readable medium having computer-executable instructions stored thereon for establishing a communication between a first party and a second party, the computer-executable instructions comprising instructions for:
receiving a communication request (CR) and identification information of the first party from the first party using a first signalization standard and using public identification information of the second party; and
establishing direct communication between the first and the second party using a second signalization standard and using the identification information of the first party;
wherein the first signalization standard corresponds to a Public Switched Telephone Network (PSTN) or Public Land Mobile Network (PLMN) service or to Internet Protocol; and
wherein the second signalization standard corresponds to Internet Protocol.
